(19) United States
(12) Patent Application Publication
(10) Pub. No.: US 2004/0138903 A1
(43) Pub. Date: Jul. 15, 2004

(54) Employment management tool and method

(76) Inventor: Sara Suzanne Zuniga, Colorado Springs, CO (US)

Correspondence Address: Law Office of Dale B. Halling, LLC, Suite 311, 24 South Weber Street, Colorado Springs, CO, 80903, US

(21) Appl. No.: 10/384,124

(22) Filed: Mar. 7, 2003

Related U.S. Application Data
(60) Provisional application No. 60/439,901, filed on Jan. 13, 2003.

(51) Int. Cl. G06F 17/60

(52) U.S. Cl. 705/1; 705/11

(57) ABSTRACT

An employment management tool has an employment management program. The employment management program has a notification component, an evaluation component, a form server and a process manager. A server is coupled to a data network and runs the employment management program. A database is coupled to the server.

### RELATED APPLICATIONS

The present application claims priority on the provisional patent application entitled “PFR” filed on Jan. 13, 2003, having application No. 60/439,901.

### FILED OF THE INVENTION

The present invention relates generally to the field of computer software and more particularly to an employment management tool and method.

### BACKGROUND OF THE INVENTION

Managing employees in many industries is a time consuming and expensive process. There have been a number of tools designed to ease this processes. For instance, online job posting and receipt of resumes has reduced the amount of paper work in the hiring process. There also exist software tools for scoring applications and hiring tests. In addition, there are software tools for the employee review process. Unfortunately, most of these tools are focused on reducing the paper work involved in these processes. In addition, none of these tools are designed to work with each other. As a result, these tools do not provide and overall framework for the employee management process. In addition, these tools are not designed to provide feedback to improve employee management decisions.

Thus there exists a need for an employment management tool and method that provides an integrated view of the employee management process and provides feedback for improved decision making.

### SUMMARY OF INVENTION

An employment management tool has an employment management program. The employment management program has a notification component, an evaluation component, a form server and a process manager. A server is coupled to a data network and runs the employment management program. A database is coupled to the server. In one embodiment, a company client program runs on a computer coupled to the data network. In another embodiment, the data network is an internet.

In one embodiment, the notification component transmits a notification. In another embodiment, the evaluation component scores a number of responses to a form. In another embodiment, the form server stores a hiring form, an exiting form and an employee review form. In yet another embodiment, the process manager controls the notification component, the evaluation component and the form server for an employee management process.

In one embodiment, the employment management program performs the steps necessary in an on-line job application procedure. In another embodiment the database stores a result of an employee management process.

In one embodiment, an automated employment management tool includes a hiring process component. A performance review component is coupled to the hiring process component. An exiting process component is coupled to the hiring process component. In one embodiment the tool includes an applicant tracking system coupled to the hiring process component. In another embodiment, the hiring process component transmits a hiring information to a payroll system.

In one embodiment, the tool includes a performance management component coupled to the performance review component. In another embodiment, a 360 degree review component is coupled to the management component.

In one embodiment, the exiting component has a key reasons for exit portion that is used to adjust a part of the hiring component.

In one embodiment, an automated employment management method includes the steps of transmitting an electronic application to an applicant in response to a request. Next the responses are received. The responses are evaluated based on a predefined criteria by the employment management program to form a continue candidate decision or a discontinue candidate decision. In one embodiment, when the continue candidate decision is formed, a request for an interview is electronically transmitted. The interview responses are received. The interview responses are evaluated based on a predefined criteria by the employment management program to form an interview continue candidate decision or an interview discontinue candidate decision.

In one embodiment, when the continue candidate decision is formed, an electronic test is electronically transmitted to the applicant. The electronic test responses are evaluated based on a predefined criteria by the employment management program to form an electronic test continue candidate decision or an electronic test discontinue candidate decision.

In one embodiment, when the discontinue candidate decision is formed, a notification is electronically transmitted to the applicant.

In one embodiment when the interview continue candidate decision is formed, electronically preparing an offer letter.

### BRIEF DESCRIPTION OF THE DRAWINGS

FIG. 1 is a block diagram of an employment management tool in accordance with one embodiment of the invention;

FIG. 2 is a block diagram of the process used in an employment management program in accordance with one embodiment of the invention;

FIG. 3 is a flow chart of the steps used in an automated employment management method tool in accordance with one embodiment of the invention;

FIG. 4 is a screen shot of a summary page of all the candidates in progress in accordance with one embodiment of the invention;

FIG. 5 is a screen shot of an individual candidate's progress in accordance with one embodiment of the invention; and

FIG. 6 is an example of automatically generated email in accordance with one embodiment of the invention.

### DETAILED DESCRIPTION OF THE DRAWINGS

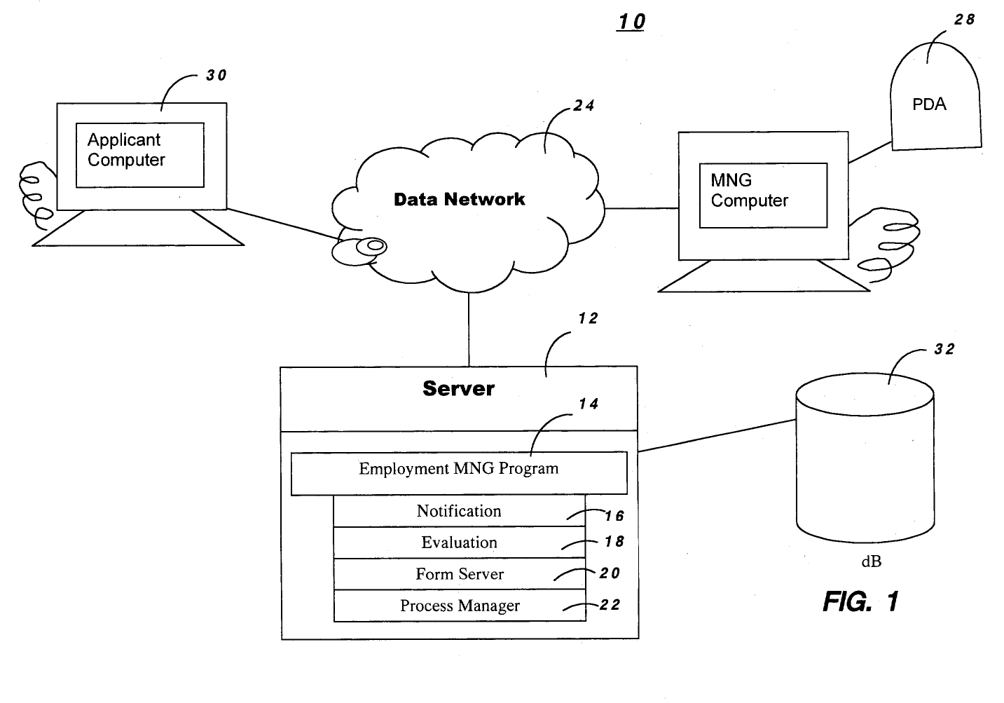

FIG. 1 is a block diagram of an employment management tool 10 in accordance with one embodiment of the invention. The employment management tool 10 has a server 12 that runs an employment management program 14. The employment management software 14 has a notification component 16, an evaluation component 18, a form server 20 and a process manager 22. The server 12 is coupled to a data network 24. The data network may be the internet or a corporate network or a combination of both. A manager's computer 26 is coupled to the data network 24. In one embodiment, the manager's computer 26 runs a company client program. The manager's computer 26 may be coupled to a personal digital assistant (PDA) 28. The PDA 28 may connect to the computer 26 by a cable or by a wireless connection. An applicant's computer 30 is also coupled to the data network 24. In one embodiment, the employment management program 14 may be coupled to a payroll system and share information with the payroll system.

In one embodiment, job opening is posted electronically using the tool 10. The job opening may be hosted by the server 12. An applicant using their computer 30 expresses an interest in the position. This may be performed by sending an email or selecting a button on a web site and will be called a request for an application. The request for an application is processed by the process manager 22. The process manager 22 directs the forms server 20 to transmit a job application to the applicant's computer 30. The application responses are stored in a database 32 coupled to the server 12 and are scored by the evaluation component 18. In one embodiment, the evaluation component 18 provides a continue candidate decision or a discontinue decision candidate decision. A discontinue candidate decision may occur because the applicant cannot show that they have the correct documentation to be allowed to work in the United States. In another embodiment, the evaluation component provides a score for the application. For instance, having no work experience in a related area might receive a zero while having at least two years experience might receive ten points. A continue candidate decision may then be made based on a threshold score for all the questions. The manager's computer 26 receives a message that a job application has been received and a score or decision of the evaluation component 18. When the continue candidate decision is reached, the manager is asked by the process manager 22 for a date and time for a phone interview. This information is forwarded to the notification component 16, and a standard message from the database 32 is sent to the applicant's computer asking them if they are available for a phone interview at that time and date. If the applicant agrees to that time and date, a message is sent to the manager's computer 26 that the phone interview is sent up. The notification component 16 also dockets a notification message for the manager and possibly for the applicant. This notification message may be sent to a PDA 28.

The manager is provided a phone interview form from the database 32 to perform the interview. In one embodiment, the questions in the form are determined based on the application or an application test. For instance, the form may ask the manager to determine why an applicant was terminated at a previous job. The manager enters in responses to the questions on the interview form in their computer 26. These phone interview responses are evaluated using the evaluation component 18. The answers and the decision or score provided by the evaluation component is stored in the database 32. The questions to the phone interview may include why the applicant wants to work for the company. In one embodiment, the manager enters a score for the phone interview into system 10. In one embodiment, the server has a web conferencing capability. This allows for a web conference interview.

In one embodiment, the hiring process includes the following steps: 1) application; 2) phone interview; 3) test(s); 4) in-house interview; 5) background search and reference check; and 6) offer. All of these steps are automated or augmented by the employment management program 14. A human performs the interviews, however they are provided with specific questions and the answers are evaluated by the program 14. The background check and reference check is also performed by a human. Again the person is provided with a form and the answers are scored by the evaluation component 18. The offer letters are generated by the employment management program 14. In one embodiment, when the candidate accepts the position the employment management program notifies the payroll system of the salary, start date, social security number, etc. In addition, to the hiring process the system 10 is used for employee reviews, 360 degree reviews, employee management reviews and the exit process. The system provides a more standardized employee management process by providing standardized processes and feedback between the various stages of the employee management process. The employees' progress in their career can be easily tracked and compared to employees in similar positions. The system 10 has feedback features for instance the review information of an employee review is used to adjust the score to various parts of the hiring process. For example, if employees who live more than five miles away quit their job within a year while employees who live less than three miles stay for three years on average a question about how close an applicant lives to the work site may be given additional weight. In another example, people who have a certain educational experience tend to have higher performance reviews. This information is used to adjust the weighting of the education experience in the application. The weighting may be binary decision or just emphasizing the question compared to other questions. These sort of feedback process may be automated. The evaluation component 18 performs a statistical correlation between the job evaluations, exiting evaluations and the hiring evaluations. Where a strong correlation exists, a suggested strategy is provided by the evaluation component. When employees exiting the company either voluntarily or being terminated, there are a number of procedures that the exit process requires to be performed correctly and to limit legal liabilities. An exiting process for a voluntarily exiting employee might include, an exit interview and asking the employee to sign a letter that they understand they are required to keep the company's trade secrets—secret. The exit interview questions may be used to help determine which type of employees the company wants to attract in the future. The exit interview may be in person or sent in a written form or may be a combination of both. For an employee being terminated there are a number of potential legal issues involved. The employment management program makes sure that all the proper steps are followed and just as importantly that there is proper documentation for the termination.

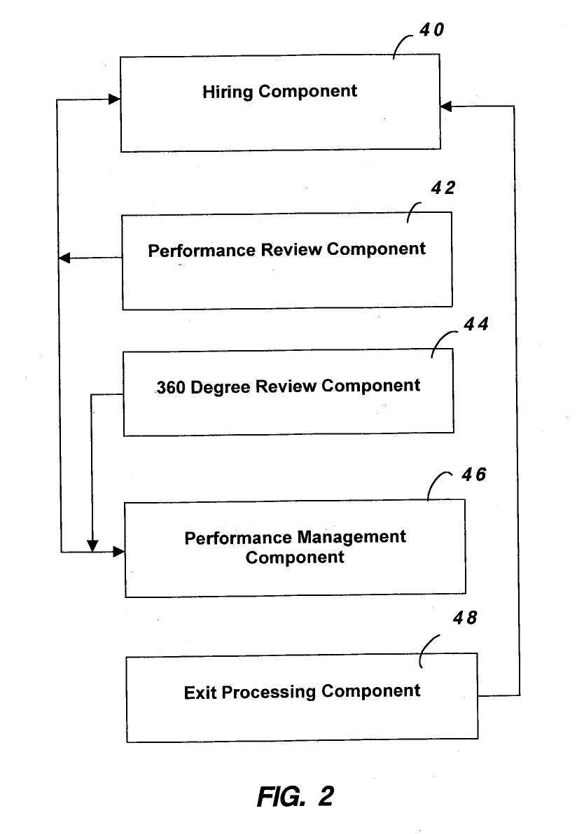

FIG. 2 is a block diagram of the process used in an employment management program 14 in accordance with one embodiment of the invention. The program has a hiring process component 40. A performance review component 42 is coupled to the hiring component 40. The performance review component 42 includes forms for a standard performance review. In addition, previous performance reviews are provided to the employee and the manager. The results of a performance review are compared against the questions and tests of the hiring component 40 by the evaluation component. Where a consistent problem or positive result is found, the questions in the hiring process are either modified or scored differently. For instance, if people without a course in accounting consistently make poor purchasing decisions then a question might be included in the hiring component about whether the applicant has taken an accounting course. The performance review component 42 is also coupled to a performance management component 46. The performance management component 46 helps to design a program of skills the employee needs to improve their performance for promotion or advancement. The performance management component 46 might suggest a public speaking course for employees who are shy or have problems communicating with their co-workers. A 360 degree review component 44 is coupled to the performance management program 46. A 360 degree review component 44 is a system where an employee is reviewed by superiors, co-workers and subordinates. These reviews can reveal concerns not found in a standard performance review. These concerns are transmitted to the performance management component 46 and the performance management component 46 creates a program for the employee to improve in these areas. An exit processing component 48 deals with the concerns that arise when an employee quits or is terminated. The exit processing component 48 is coupled to the hiring component 40. The exiting process can reveal many issues that can be used to adjust the emphasis or questions in the hiring process component 40. In one embodiment, the hiring component 40, exit processing component 48 and the performance review component 42 are coupled to a payroll system. This facilitates an employee getting paid and stopping the system for issuing checks for a non-existent employee. By integrating all these processes in a single system information may be shared between components. In addition, feedback from one component can be used to adjust the process in another component. As a result, the system reduces the time and effort for employee management and increases the effectiveness of the various employee management components.

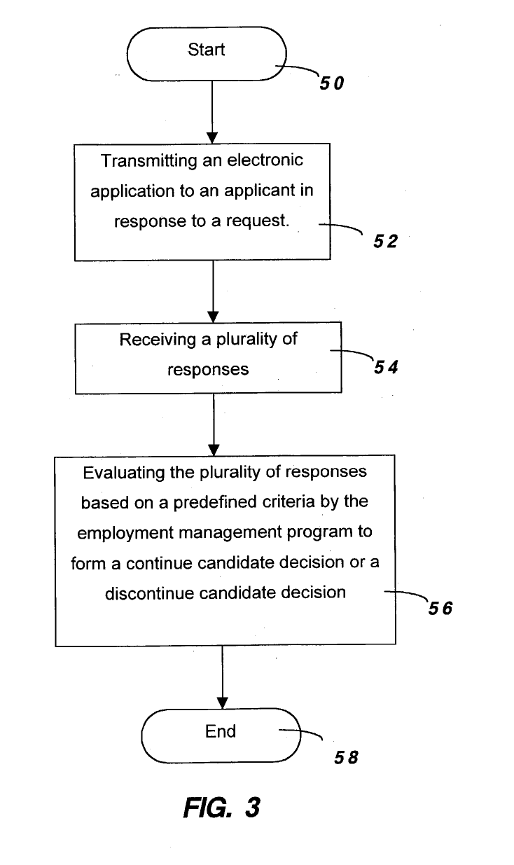

FIG. 3 is a flow chart of the steps used in an automated employment management method tool in accordance with one embodiment of the invention. The process starts, step 50, by transmitting an electronic application to an applicant in response to a request at step 52. A plurality of responses are received at step 54. At step 56, the responses are evaluated based on a predefined criteria by the employment management program to form a continue candidate decision or a discontinue candidate decision which ends the process at step 58. When a continue candidate decision is formed, a request for an interview is electronically transmitted to the applicant. Responses from the interview are received and evaluated based on a predefined criteria by the employment management candidate. A continue or discontinue decision is made by the program.

In one embodiment, when a continue candidate decision is formed, an electronic test is transmitted to the applicant. The responses are evaluated based on predefined criteria by the program. A continue or discontinue decision is made by the program.

When a discontinue candidate decision is formed, a notification is electronically transmitted to the applicant.

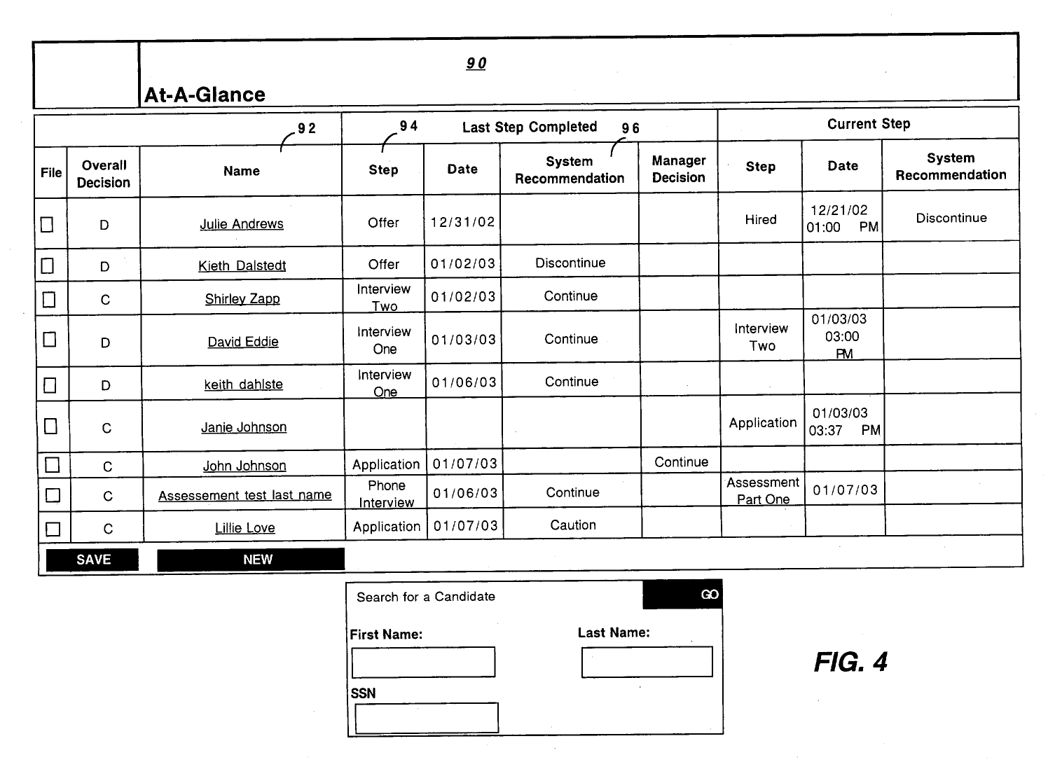

FIG. 4 is a screen shot of a summary page 90 of all the candidates in progress in accordance with one embodiment of the invention. The summary page 90 has a column of the names 92 of the candidates, and the step 94 they are in the hiring process, the system recommendation 96 among other information. This allows the manager at a glance to review their progress at hiring a person for a position.

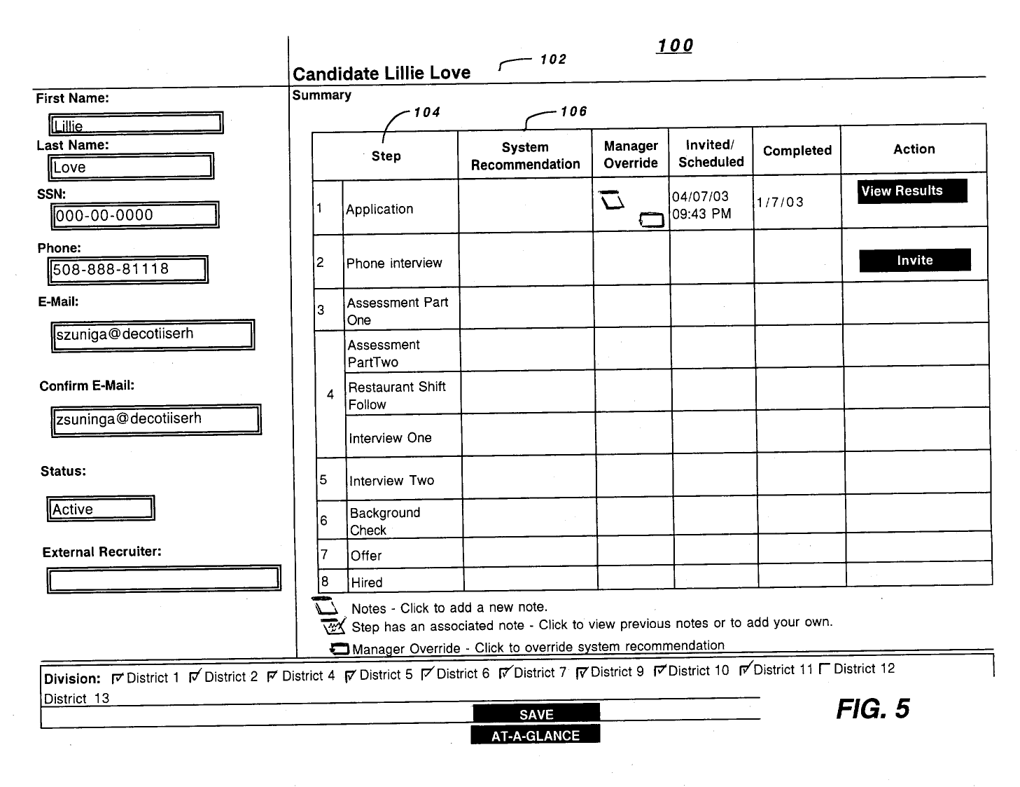

FIG. 5 is a screen shot of an individual candidate's progress 100 in accordance with one embodiment of the invention. The screen 100 shows the candidate's name 102, the steps 104 in the hiring process and the system's recommendation 106 at each step.

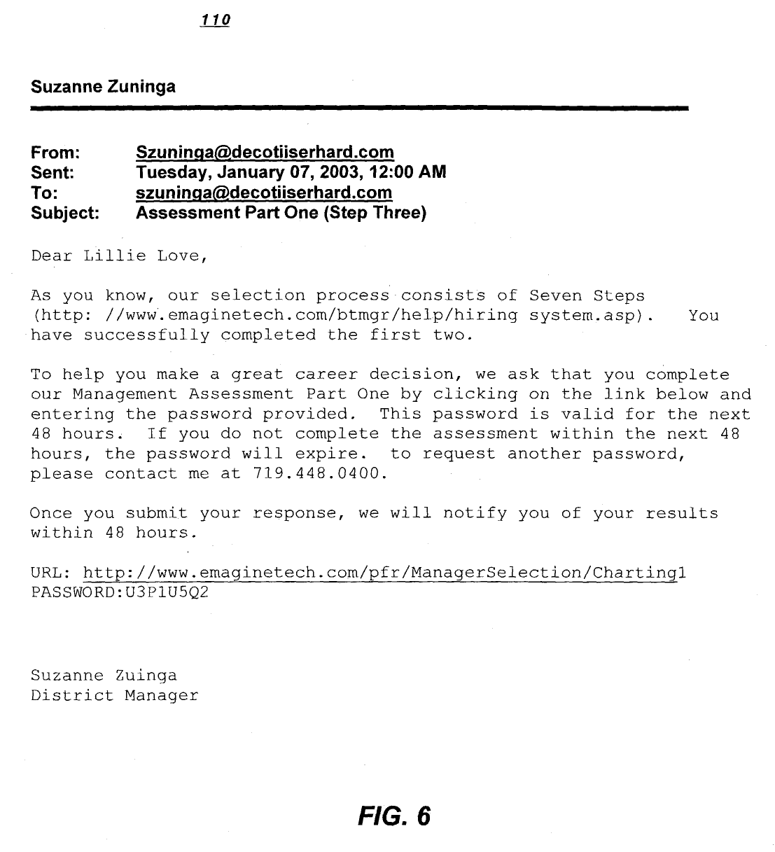

FIG. 6 is an example of automatically generated email 110 in accordance with one embodiment of the invention. This is a form email that is sent to a candidate when they are requested to take the management assessment test. The form email saves the manager time and reduces the variations in the hiring process.

Thus there has been described an employment management tool and method that provides an integrated view of the employee management process and provides feedback for improved decision making.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. An employment management tool, comprising:
an employment management program having a notification component, an evaluation component, a form server and a process manager;
a server coupled to a data network running the employment management program; and
a database coupled to the server.

2. The tool of claim 1, further including a company client program running on a computer coupled to the data network.

3. The tool of claim 2, wherein the data network is an internet.

4. The tool of claim 1, wherein the notification component transmits a notification email.

5. The tool of claim 1, wherein the evaluation component scores a plurality of responses to a form.

6. The tool of claim 5, wherein the form server stores a hiring form, an exiting form and a employee review form.

7. The tool of claim 1, wherein the process manager controls the notification component, the evaluation component and the form server for an employee management process.

8. The tool of claim 1, wherein the employment management program performs the steps necessary in an on-line job application procedure.

9. The tool of claim 1, wherein the database stores a result of an employee management process.

10. An automated employment management tool, comprising:
a hiring process component;
a performance review component coupled to the hiring process component; and
an exiting process component coupled to the hiring process component.

11. The tool of claim 10, further including an applicant tracking system coupled to the hiring process component.

12. The tool of claim, 10 wherein the hiring process component transmits a hiring information to a payroll system.

13. The tool of claim 10, further including a performance management component coupled to the performance review component.

14. The tool of claim 13, further including a 360 degree review component coupled to the performance management component.

15. The tool of claim 10, wherein the exiting component has a key reasons for exit portion that is used to adjust a part of the hiring component.

16. An automated employment management method, comprising the steps of:
a) transmitting an electronic application to an applicant in response to a request;
b) receiving a plurality of responses; and
c) evaluating the plurality of responses based on a predefined criteria by the employment management program to form a continue candidate decision or a discontinue candidate decision.

17. The method of claim 16, further including the steps of:
d) when the continue candidate decision is formed, electronically transmitting a request for an interview;
e) receiving a plurality of interview responses from the interview;
f) evaluating the plurality of interview responses based on a predefined criteria by the employment management program to form an interview continue candidate decision or an interview discontinue candidate decision.

18. The method of claim 16, further including the steps of:
d) when the continue candidate decision is formed, electronically transmitting an electronic test to the applicant;
e) receiving a plurality of electronic test responses;
f) evaluating the plurality of electronic test responses based on a predefined criteria by the employment management program to form an electronic test continue candidate decision or an electronic test discontinue candidate decision.

19. The method of claim 16, further including the step of:
d) when the discontinue candidate decision is formed, electronically transmitting a notification to the applicant.

20. The method of claim 17, further including the step of:
g) when the interview continue candidate decision is formed, electronically preparing an offer letter.
